(19) United States
(12) Patent Application Publication
(10) Pub. No.: US 2025/0308062 A1
(43) Pub. Date: Oct. 2, 2025

(54) IMAGE RENDERING METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventors: Jiawei WEN, Beijing (CN); Hengkai GUO, Beijing (CN)

(21) Appl. No.: 18/864,131

(22) PCT Filed: Apr. 28, 2023
(86) PCT No.: PCT/CN2023/091479

§ 371 Date: Nov. 8, 2024

(30) Foreign Application Priority Data
May 9, 2022 (CN) 202210501160.9

(51) Int. Cl. G06T 7/73; G06T 15/00; G06V 10/44

(52) U.S. Cl. CPC G06T 7/73; G06T 15/005; G06V 10/44

(57) ABSTRACT

Embodiments of the present disclosure provide an image rendering method and apparatus, an electronic device, and a storage medium. The method includes: determining whether a received current frame is a key frame based on a key frame group to be updated located by a simultaneous localization and mapping system, the key frame group to be updated including at least one key frame to be applied; in response to determining that the received current frame is a key frame, updating the key frame group to be updated according to a preset frame number and the current frame to obtain an updated key frame group to be updated; and optimizing a key frame to be applied in the updated key frame group to be updated, and updating a relative pose of the key frame to be applied, so as to perform image rendering based on an updated relative pose.

The present application claims priority of the Chinese Patent Application No. 202210501160.9, filed in China National Intellectual Property Administration on May 9, 2022, and the entire contents of the Chinese Patent application are incorporated into the present application by reference.

### TECHNICAL FIELD

Embodiments of the present disclosure relate to the technical field of image processing, for example, to an image rendering method and apparatus, an electronic device, and a storage medium.

### BACKGROUND

With the development of computer vision technology, a simultaneous localization and mapping (SLAM) algorithm is widely applied in fields such as augmented reality (AR), virtual reality (VR), autonomous driving, and localization and navigation for robots or drones.

Based on the SLAM algorithm, various types of systems can be constructed to perform corresponding rendering tasks, such as a filter-based SLAM system and a feature-point-based SLAM system. However, in practical application, the filter-based SLAM system cannot provide accurate camera pose information and spatial information, which is obtained by capturing, for a long period of time, which results in poor effect of the image rendered by the system; and the feature-point-based SLAM system requires to extract the feature points from images and matches the feature points in respective frames, the disadvantage of this approach is that it not only increases the computational overhead in the image processing process, but also makes it difficult to process images captured on a mobile terminal in real time, thus affecting the user experience.

### SUMMARY

The present disclosure provides an image rendering method and apparatus, an electronic device, and a storage medium, which enhance the SLAM-based spatial positioning accuracy, optimize the rendering effect of the image, and at the same time, improve the image rendering efficiency, and ensure real-time processing of images captured on the mobile terminal.

In a first aspect, an embodiment of the present disclosure provides an image rendering method, comprising:
determining whether a current frame that is received is a key frame based on a key frame group to be updated located by a simultaneous localization and mapping system, the key frame group to be updated comprising at least one key frame to be applied;
in response to determining that the current frame that is received is a key frame, updating the key frame group to be updated according to a preset frame number and the current frame to obtain an updated key frame group to be updated; and
optimizing a key frame to be applied in the updated key frame group to be updated, and updating a relative pose of the key frame to be applied, so as to perform image rendering based on an updated relative pose.

In a second aspect, an embodiment of the present disclosure also provides an image rendering apparatus, comprising:
a key frame determination module, configured to determine whether a current frame that is received is a key frame based on a key frame group to be updated located by a simultaneous localization and mapping system, the key frame group to be updated comprising at least one key frame to be applied;
an updating module, configured to, in response to determining that the current frame that is received is a key frame, update the key frame group to be updated according to a preset frame number and the current frame to obtain an updated key frame group to be updated; and
a to-be-applied key frame optimization module, configured to optimize a key frame to be applied in the updated key frame group to be updated, and update a relative pose of the key frame to be applied, so as to perform image rendering based on an updated relative pose.

In a third aspect, an embodiment of the present disclosure also provides an electronic device, comprising:
at least one processor; and
a storage apparatus, configured to store at least one program;
when the at least one program is executed by the at least one processor, the at least one processor implements the image rendering method according to any embodiment of the present disclosure.

In a fourth aspect, an embodiment of the present disclosure also provides a storage medium, comprising computer-executable instructions, and the computer-executable instructions, when executed by a computer processor, are used to perform the image rendering method according to any embodiment of the present disclosure.

### BRIEF DESCRIPTION OF DRAWINGS

Throughout the accompanying drawings, the same or similar reference numerals indicate the same or similar elements. It should be understood that the accompanying drawings are schematic and that components and elements are not necessarily drawn to scale.

FIG. 1 is a schematic flow diagram of an image rendering method according to embodiments of the present disclosure;

FIG. 2 is a schematic structural diagram of an image rendering apparatus according to embodiments of the present disclosure; and

FIG. 3 is a schematic structural diagram of an electronic device according to embodiments of the present disclosure.

### DETAILED DESCRIPTION

Embodiments of the present disclosure will be described in more detail below with reference to the accompanying drawings.

It should be understood that the plurality of steps recorded in the implementation modes of the methods of the present disclosure can be performed according to different orders and/or performed in parallel. In addition, the implementation modes of the methods can include additional steps and/or omit performing the steps shown. The scope of the present disclosure is not limited in this aspect.

The term “comprise/include” and variations thereof used in this article are open-ended inclusion, namely “comprising/including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that the concepts, such as “first” and “second”, mentioned in the present disclosure are only used to distinguish different apparatuses, modules, or units, and are not intended to limit orders or interdependence relationships of functions performed by these apparatuses, modules, or units. It should be noted that the modifications of “one” and “more/plurality” mentioned in the present disclosure are illustrative rather than restrictive, and those skilled in the art should understand that unless otherwise explicitly stated in the context, it should be understood as “at least one”.

The names of messages or information interacted between a plurality of apparatuses in the implementations of the present disclosure are used for illustrative purposes only and are not used to limit the scope of such messages or information.

Before introducing the present technical scheme, an illustrative example of the application scenarios of embodiments of the present disclosure can be provided. For example, when a user captures a video by using a camera apparatus on a mobile terminal and uploads the captured video to a system based on SLAM algorithm, or, selects a target video from a database and actively uploads the video to the system based on SLAM algorithm, the system can parse the video. However, it is difficult for the SLAM system in the related art to provide accurate camera pose information and spatial information for a long period of time, which results in poor image rendering effects; or, the SLAM system requires to extract the feature points from video frames and performs feature matching, in this process, a relatively large computational overhead makes it difficult to process the video captured by the mobile terminal in real time. In this case, based on the scheme of the embodiments of the present disclosure, a key frame group to be updated can be directly determined in the video, the key frame group to be updated can be updated according to a preset frame number and a current key frame, and a relative pose of the key frame can be obtained after the key frame is optimized, thereby improving the SLAM-based spatial positioning accuracy and obtaining more excellent rendering results. At the same time, the SLAM system provided by the embodiments of the present disclosure does not need to extract and match the feature points in the image, thus reducing the computational overhead and facilitating real-time processing of images uploaded by the mobile terminal.

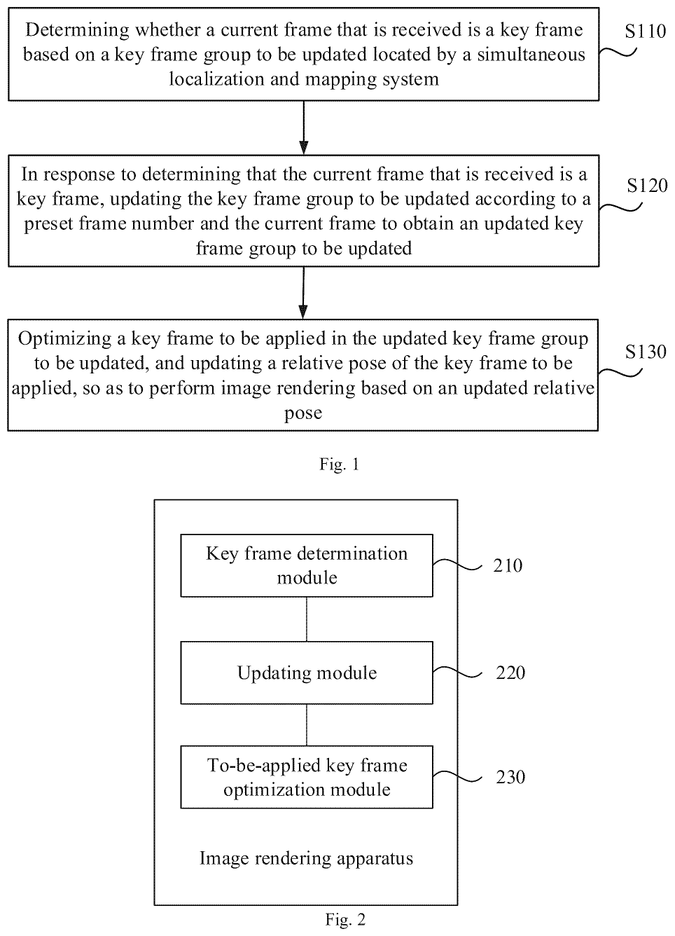

FIG. 1 is a schematic flow diagram of an image rendering method according to embodiments of the present disclosure. The embodiments of the present disclosure are applicable for a situation that a video is processed based on a SLAM system, thereby rendering a plurality of frames of images in real time on a display interface. The method can be performed by an image rendering apparatus. The apparatus can be implemented by software and/or hardware, or alternatively, by an electronic device, and the electronic device can be a mobile terminal, a PC terminal, or a server, etc.

As shown in FIG. 1, the method includes the following steps.

In S110, determining whether a current frame that is received is a key frame based on a key frame group to be updated located by a simultaneous localization and mapping system.

The SLAM technology is mainly used to solve the problems of localization, navigation, and map construction for mobile robots operating in unknown environments. It can be understood that the SLAM system in the embodiments of the present disclosure is a system integrated with SLAM-related algorithms. These algorithms typically include several parts such as feature extraction, data association, state estimation, state update, and feature update. There are multiple processing methods for each of these parts, which is not limited by the embodiments of the present disclosure.

In this embodiment, the SLAM system for executing the image rendering method provided by the embodiments of the present disclosure can be integrated into application software supporting a special effect video processing function, and the software can be installed in an electronic device. Alternatively, the electronic device can be a mobile terminal or a PC terminal, etc. The application software can be a type of software for image/video processing, and the specific application software will not be described in detail here, as long as it can realize image/video processing. The application software can also be a specially developed application program, which is integrated in the software that adds the special effects and displays the special effects, or is integrated in the corresponding page, and the user can achieve to process the special effect video through the integrated page in the PC terminal.

It should be noted that the technical scheme of this embodiment can be executed either during a process of capturing the video based on the mobile terminal in real time or after the system receives video data actively uploaded by users. Meanwhile, the scheme of the embodiment of the present disclosure can be applied to various application scenarios, including Augmented Reality (AR), Virtual Reality (VR), and autonomous driving.

In this embodiment, prior to rendering the image based on the SLAM system, it is necessary to first identify a key frame group to be updated within the received or acquired video data. The key frame group to be updated is a set comprising a plurality of key frames, and an image in the key frame group to be updated can also be updated based on the SLAM system provided by the embodiments of the present disclosure. Moreover, the key frame group to be updated comprises at least one key frame to be applied. It should be understood by those skilled in the art that in the field of computer vision technology, a key frame is used to represent a plurality of frames adjacent to the key frame, is equivalent to the backbone of SLAM, and is a frame selected from a series of local ordinary frames as the representative of the local frames. Hence, at least the local information of a video frame is recorded in the key frame. At the same time, utilizing the key frames to perform the subsequent image rendering processing process can also effectively reduce the number of video frames that need to be optimized, thereby enhancing the image processing efficiency of the system.

For example, after receiving the video data, the SLAM system can store the video in a preset sequence. For example, the preset sequence can store the video in the order of the frames in the video. For example, if the frames in the video are arranged in the order of frame 1, followed by frame 2, . . . followed by frame n−1, and finally followed by frame n, then the preset sequence stores the video according to the above order, that is, in the order of frame 1, frame 2 . . . frame n−1, and frame n. Meanwhile, the plurality of video frames collectively constitute a key frame group to be updated, in which frame 1, frame 10, frame 20 . . . frame n serve as the key frames to be applied, each of which represents a plurality of frame adjacent thereto.

In this embodiment, before the SLAM system determines whether the received current frame is a key frame or not, it is also possible to preprocess a plurality of consecutive frame images when receiving the plurality of consecutive frame images for the first time to determine at least one initialization key frame; and the at least one initialization key frame is taken as the at least one key frame to be applied in the key frame group to be updated.

The plurality of consecutive frame images can be images parsed by the system from the received video data, such as frame 1, frame 2 . . . frame n−1, and frame n in the above example. Those skilled in the art should understand that the plurality of consecutive frame images can be determined according to the actual situation. Additionally, the system can pre-construct an adaptively sized sliding window, so that after receiving the plurality of consecutive frame images, the images are preprocessed and the sliding window is used to screen out the at least one initialization key frame from the plurality of consecutive frame images.

In this embodiment, the preprocessing includes an operation of eliminating rotational influence. Here, the reason for the preprocessing is that in a plurality of consecutive video frames, the image may be rotated, which affects the pixel distance difference between frames. However, rotation alone cannot be used for SLAM initialization. Therefore, in order to solve this problem, the embodiments of the present disclosure perform the aforementioned preprocessing and utilize the pixel distance difference with rotational influence eliminated to select at least one initialization key frame within the window, thus ensuring that the frames within the window have sufficient parallax for SLAM initialization under the premise of having enough co-visibility. It can be understood that by eliminating rotational influence, the impact of rotation on SLAM initialization is reduced, thus improving the accuracy of SLAM initialization.

In practical application, the system can obtain the information of the rotation from an inertial measurement unit, so as to determine the pixel distance difference between the frames affected by the rotation based on the obtained information, perform the processing of eliminating rotational influence on the plurality of consecutive frame images, and screen out the at least one initialization key frame in the sliding window by using the pixel distance difference with rotational influence eliminated.

Alternatively, the system can filter out the at least one initialization key frame from the plurality of consecutive frame images with rotational influence eliminated by using the pre-established sliding window with an adaptive size, and this process will be described in detail below.

For example, relative poses of a first key frame and a last key frame among a plurality of key frames are determined; according to the relative poses of the first key frame and the last key frame, a three-dimensional spatial point of each key frame of the plurality of key frames is obtained; according to the relative poses of the first key frame and the last key frame and the three-dimensional spatial point of each key frame of the plurality of key frames, a relative pose of each key frame of the plurality of key frames is determined; and according to the three-dimensional spatial point of each key frame of the plurality of key frames and the relative pose of each key frame of the plurality of key frames, an initial map is established. After the initial map is established, the preprocessing operation on the plurality of consecutive frame images can be performed.

For example, the system pre-establishes a sliding window with an adjustable size, such as a sliding window with an image frame size being approximately 5 frames to 10 frames. The sliding window can be used to screen out the at least one initialization key frame from the plurality of consecutive frame images with rotational influence eliminated. For example, if the current length of the sliding window is 5 frames, the system utilizes the pixel distance difference with rotational influence eliminated to select the initialization key frames within the sliding window. For example, frame 1, frame 2, . . . frame 25 which are parsed from the received video are screened out, so that frames 6, 7, 10, 12, and 13 are selected as the initialization key frames. Based on this, if the SLAM initialization cannot be correctly performed through the size of these 5 frame images, the size of the sliding window is increased to 6 frames, then continuing to screen out the initialization key frames with rotational influence eliminated according to the method described above, performing initialization calculation and sliding window adjustment until the SLAM initialization is completed. It can be understood that the obtained at least one initialization key frame is at least one key frame to be applied in the key frame group to be updated.

In this embodiment, the system performs SLAM initialization based on the initialization key frames selected from the plurality of consecutive frame images, which reduces the time for SLAM initialization. Moreover, the system utilizes the pixel distance difference with rotational influence eliminated to select the initialization key frames within the window, thus ensuring that the frames within the window have sufficient parallax for SLAM initialization under the premise of having enough common views. Meanwhile, the impact of rotation on SLAM initialization is reduced, thus improving the accuracy of SLAM initialization.

It should be noted that before determining whether the received current frame is a key frame, the method further includes: determining point cloud data (PCD) to be processed in the current frame based on a corner detection algorithm, so as to process the PCD to be processed based on the at least one key frame to be applied to obtain an optimized pose of the current frame, thereby determining whether the current frame is a key frame.

In this embodiment, upon receiving the current frame, the system first needs to determine the PCD in the current frame based on the corner detection algorithm. The PCD is usually used in reverse engineering, and is kind of data recorded in the form of points. These points can be coordinates in three-dimensional space, or information such as color and illumination intensity. In practical application, PCD generally also includes point coordinate accuracy, spatial resolution, surface normal vector, and the like, and are generally saved in a PCD format. In this format, the PCD has strong operability and can improve the speed of point cloud registration and fusion in the subsequent processes, which is not described in detail again in the embodiments of the present disclosure. It can be understood that in this embodiment, the PCD in the current frame is PCD to be processed.

In practical application, the corner detection algorithm adopted by the system can be a KLT corner detection method, also known as KLT optical flow tracking method. The KLT corner detection method is used to meet the requirements of the Lucas-Kanade optical flow method for selecting suitable feature points. The Lucas-Kanade optical flow method involves first establishing fixed-size windows in the two consecutive frame images respectively, then determining a displacement that minimizes the sum of the squares of intensity differences of pixels between the two windows, and approximates the movement of pixels within the window as such displacement vectors. However, in practical application, pixel movements are often complex, and at the same time, the pixels within the window do not all move in the same way. This approximate method inevitably introduces errors. Therefore, the KLT corner detection method is aimed at selecting a feature point suitable for tracking, and it can be understood that a good feature point is a point that can be better tracked by the system. In the process of using the KLT corner detection method to determine the PCD to be processed, a plurality of steps are involved, including determining a pixel point light intensity function, adjusting the energy deviation within the window to the minimum, corner selection, feature point selection, and setting a threshold for an energy deviation function to exclude blocked points, which will not be detailed in the embodiments of the present disclosure.

In this embodiment, the KLT corner detection method is used to determine the PCD in the current frame, and there is no need to extract descriptors in the current frame or perform the operation of feature point matching, thus enhancing the real-time and robustness of the system performing the data processing, and enabling the system to achieve efficient corner tracking in the process of corner tracking and determining the PCD to be processed.

In this embodiment, after obtaining the PCD to be processed in the current frame, these PCD can be processed based on the key frames to be applied, so as to obtain an optimized pose of the current frame. It should be understood by those skilled in the art that graph optimization with camera poses and spatial points is referred to as bundle adjustment (BA), which can effectively solve large-scale localization and mapping problems. However, as the scale continues to increase, the computational efficiency will significantly decrease. In this process, the optimization problem of feature points constitutes a substantial portion. After several iterations, the feature points will converge, and at this time, there will be little significance in further optimization. Therefore, in practical processes, after optimizing several times, the feature points can be fixed and regarded as constraints for pose estimation, that is, the poses of feature points are no longer optimized. Based on this, it can be understood that, the optimized pose graph is a graph optimization, with only trajectories, constructed only considering poses. An initial value of an edge between pose nodes is determined by motion estimation obtained through feature matching between two key frames. Once the initial value is determined, the position of the landmark point is no longer optimized, and only the relationship between camera poses is concerned. In this embodiment, the optimized pose is information determined based on a pose graph of the current frame. Based on this information, the system can determine whether the current frame is a key frame.

In this embodiment, the above incremental BA problem construction method is used to determine the optimized pose of the current frame, so that the SLAM system can provide a relatively high BA speed, thus ensuring the real-time processing of video frames by the system.

In this embodiment, there are many methods to determine whether the received current frame is a key frame based on the key frame group to be updated localized by the SLAM system, which will be explained one by one below.

Alternatively, target feature points of the current frame and a displacement parallax between the current frame and the at least one key frame to be applied are determined; and in response to the number of the target feature points being greater than a first preset number threshold and the displacement parallax being greater than a first preset displacement parallax threshold, it is determined that the current frame is a key frame.

Because the camera is in a state of constant motion, an object being photographed in the image exhibits motion, resulting in the displacement parallax. It can be understood that the displacement parallax can be used to determine the distance of objects in each frame image at least. Target feature points are points determined from objects in each frame image, for example, if there is a multi-level steps in a certain frame image, the system can determine a plurality of corresponding feature points from each step based on a pre-trained feature point determination algorithm. These feature points are the target feature points, and the system can use the determined plurality of feature points as an identifier to calculate changes in camera pose. Those skilled in the art should understand that in practical application, the target feature points determined by the system can be of various types, such as scale-invariant feature transform (SIFT) feature points, speeded up robust features (SURF) feature points, and oriented FAST and rotated BRIEF (ORB) feature points, etc. The type of the target feature point can be selected according to the actual situations, which is not limited by the embodiments of the present disclosure.

In this embodiment, the system can also preset a threshold for the parameter of the number of target feature points, and the threshold is the first preset number threshold. Similarly, a threshold is also preset for the parameter of the displacement parallax, and the threshold is the first preset displacement parallax threshold. Based on this, after the system has determined the target feature points from the current frame and determined the displacement parallax between the current frame and at least one key frame to be applied, the system can determine the number of the target feature points and the displacement parallax, and when the number of the target feature points and the displacement parallax both are greater than their respective preset thresholds, the current frame is determined to be a key frame.

For example, when the first preset number threshold of the system is 100 and the first preset displacement parallax threshold is 100 pixels, if it is determined that the number of the target feature points in the current frame is 300 and the displacement parallax between the current frame and the at least one key frame to be applied also reaches a length of 300 pixels, it can be determined that the above two parameters are both greater than their corresponding preset thresholds. In this case, the system can determine that the current frame is a key frame. It should be understood by those skilled in the art that if either of the above two parameters is less than or equal to the preset threshold corresponding thereto, or the two parameters both are less than or equal to their respective preset thresholds, the current frame will not be determined as a key frame, and after the current frame is discarded, a plurality of subsequently received frames will continue to be judged one by one in the same manner described above, which will not be detailed in the embodiments of the present disclosure.

Alternatively, co-visibility feature points between the current frame and the at least one key frame to be applied are determined, the downsampling processing is performed on the current frame based on the co-visibility feature points to determine target feature points, and a displacement deviation between the current frame and the at least one key frame to be applied is determined; and in response to the number of the target feature points being less than the number of feature points to be processed in the current frame and the displacement deviation being less than a second preset displacement deviation, it is determined that the current frame is a key frame.

For example, after receiving the current frame and determining a plurality of feature points in the image of the current frame, the system can also compare these feature points with feature points in an image corresponding to the at least one key frame to be applied, so as to determine the co-visibility feature points in these images, for example, matching and comparing key points and descriptors associated with feature points in a plurality of video frame images, so as to determine the co-visibility feature points. It can be understood that the co-visibility feature point is a co-visibility point between the current frame and the key frame to be applied. Still referring to the above example, after determining the feature points corresponding to the plurality of steps in the image from the received current frame, the system needs to compare these feature points with the feature points in other key frames to be applied, when an image of a certain key frame to be applied also includes the multi-level steps, that is, also includes the above feature points, the system can determine the feature points corresponding to the multi-level steps in the two video frame images as co-visibility feature points.

In this embodiment, after determining the co-visibility feature points between the current frame and the key frames to be applied, the system can downsample the co-visibility feature points in the current frame, and then screen out the target feature points from these co-visibility feature points. Those skilled in the art should understand that in the field of digital signal processing, downsampling is a multi-rate digital signal processing technology and also a process of reducing the signal sampling rate, which is usually used to reduce the data transmission rate or data amount. For example, by downsampling 160 co-visibility feature points in the current frame by a factor of 4, 40 feature points can be screened out as the target feature points. It can be understood that the parameter “4” used in the above example represents the downsampling rate, and indicates that the sampling period becomes M times the original or the sampling rate becomes 1/M times the original. Additionally, the downsampling rate can be preset manually or automatically, which is not limited by the embodiments of the present disclosure.

In this embodiment, in the process of determining the target feature points by the system, it is also necessary to determine the displacement deviation between the current frame and the key frame to be applied. The displacement deviation is the information characterizing the change in camera pose. For example, the current frame is captured when the camera is at point A in a scene, and a certain key frame to be applied is captured when the camera is at point B in the same scene. For these two frames, the change of pose caused by the camera moving from point B to point A is the displacement deviation determined by the system from the two frames.

In this embodiment, the system can also preset a threshold for the parameter of the displacement deviation, and the threshold is the second preset displacement deviation. Based on this, when the system determines the target feature points from the current frame and determines the displacement deviation between the current frame and the at least one key frame to be applied, the number of the target feature points can be compared with the number of feature points to be processed in the current frame, the displacement deviation between the current frame and the key frame to be applied is compared with the second preset displacement deviation, and when the above two parameters are both less than their respective comparison objects, the current frame is determined as a key frame.

Alternatively, PCD to be processed in the current frame is downsampled to obtain target feature points; a displacement deviation between the current frame and the at least one key frame to be applied is determined; and in response to the number of the target feature points being less than or equal to the number of co-visibility feature points and the displacement deviation being less than a third preset displacement deviation, it is determined that the current frame is a key frame.

For example, upon receiving the current frame, the system can downsample the PCD to be processed in the current frame, for example, downsampling the PCD through a voxel mesh. When the system downsamples the PCD in this way, the shape of the point cloud can still be maintained while reducing the number of points in the PCD, and the speed of algorithms such as registration, surface reconstruction, shape recognition, and the like can be improved, and the accuracy of downsampling is ensured. By downsampling the PCD, the feature points selected from the PCD can also serve as the target feature points. At the same time, the system can determine the displacement deviation between the current frame and the at least one key frame to be applied according to a manner described above for the embodiments of the present disclosure, which is not repeated herein again by the embodiments of the present disclosure.

In this embodiment, the system can preset a threshold for the parameter of the displacement deviation, and the threshold is the third preset displacement deviation, the number of the target feature points is compared with the number of co-visibility feature points among a plurality of video frames, and the displacement deviation is compared with the third preset displacement deviation. When the above two parameters are both less than their corresponding comparison objects, the current frame is determined as a key frame.

In S120, in response to determining that the current frame that is received is a key frame, updating the key frame group to be updated according to a preset frame number and the current frame to obtain an updated key frame group to be updated.

In this embodiment, after the SLAM system determines that the received current frame is a key frame, it is necessary to add the key frame to the key frame group to be updated, so as to update the key frame group to be updated. This process can be understood as updating and optimizing local map information.

Meanwhile, in the scheme of this embodiment, in order to ensure the consistency and accuracy of focus tracking, a sliding window structure is adopted to maintain local map information. Here, the sliding window can include a plurality of adjacent frames and spatial points observed based on these adjacent frames. Based on this, in the process of local optimization of map information, it is necessary to use historical information to constrain the current frame, so as to improve the accuracy of optimization results for local map information. In the practical application process, a frame number can be preset for the sliding window structure, and the frame number also determines the number of key frames in the key frame group to be updated. It can be understood that by strictly controlling the number of key frames in the key frame group to be updated, the number of local map points is indirectly controlled, thus effectively controlling the subsequent calculation efficiency and facilitating the real-time processing on images captured by the mobile terminal by the SLAM system.

Alternatively, in response to the number of the at least one key frame to be applied being less than the preset frame number, the current frame is updated to the key frame group to be updated to obtain the updated key frame group to be updated.

For example, when the sliding window can include at most 10 adjacent key frames as the key frames to be applied, the preset frame number is 10, and the number of key frames to be applied in the current key frame group to be updated is 6, that is, the number of the key frames to be applied is less than the preset frame number, at this time, after the SLAM system adds the current frame to the key frame group to be updated, the current frame becomes a new key frame to be applied, and the key frame group comprising 7 key frames is the updated key frame group to be updated. In this process, the system does not need to make any processing for the original 6 key frames to be applied in the key frame group to be updated.

If the number of the at least one key frame to be applied is greater than or equal to the preset frame number, the current frame is updated to the key frame group to be updated, and a key frame to be applied with a longest interval from current time is removed from the key frame group to be updated to obtain the updated key frame group to be updated.

For example, when the sliding window can include at most 10 adjacent key frames as the key frames to be applied, the preset frame number is 10, and the number of key frames to be applied in the current key frame group to be updated is also 10, that is, the number of key frames to be applied is equal to the preset frame number, after the SLAM system adds the current frame to the key frame group to be updated, in order to ensure that the number of key frames to be applied in the key frame group to be updated is equal to the preset frame number, it is necessary to select a key frame to be applied with the earliest timestamp from the 10 key frames to be applied which serve as historical key frames, and remove the selected key frame to be applied from the key frame group to be updated, thus ensuring the consistency of the size of the sliding window.

In S130, optimizing a key frame to be applied in the updated key frame group to be updated, and updating a relative pose of the key frame to be applied, so as to perform image rendering based on an updated relative pose.

In this embodiment, after the SLAM system finishes updating the key frame group to be updated, the key frame to be applied in the updated key frame group to be updated can be optimized, so as to update the relative pose of each frame. Alternatively, the key frames to be applied are optimized based on the BA method, so as to update the relative poses of the key frames to be applied.

The BA method utilizes the projections of all points in the image as standard to simultaneously extract 3D point coordinates, relative motion parameters, and camera optical parameters describing the scene structure. It can be understood that for any three-dimensional point P in the scene, rays of light emitted from the optical centers of cameras corresponding to respective views and passing through the pixel corresponding to P in the image will all intersect at the point P, for all three-dimensional points, then numerous bundles of rays are formed. In actual application, due to factors like noise, it is almost impossible for each ray to converge at one point, necessitating continuous adjustments to the information to be solved during the process of solving to ensure that the rays of light can finally intersect at point P. It can be understood that the ultimate goal of the BA method is to minimize errors in the positional projection transformations between the points of key frames to be applied as observation images and the points of reference or predicted images, thereby obtaining optimal estimates of 3D structure and motion parameters (such as, camera matrix).

In this embodiment, the BA method usually uses the sparsity of a BA model for calculation, and in the calculation process, the steepest descent method, Newton-type method, LM method, etc. may be involved, which is not limited by the embodiments of the present disclosure. After optimizing the key frames to be applied by the BA method, the update of the relative poses of the key frames to be applied can be achieved.

In this embodiment, after updating the relative poses of the key frames to be applied in the updated key frame group to be updated, the updated relative poses and the optimized poses of the key frames to be applied in the updated key frame group to be updated can be sent to a graphics processing unit (GPU), and map data can be updated based on the GPU.

For example, after the SLAM system determines the updated relative pose and the optimized pose of each key frame to be applied, the SLAM system can write the information into a rendering engine, so that the rendering engine can render corresponding images in a display interface. Here, the rendering engine is a program that controls the GPU to render relevant images, that is, the rendering engine can make a computer complete a map drawing task for a scene captured by a camera. For example, when the current scene includes a first floor and a second floor in a building, and the GPU has already drawn the map of the first floor based on multiple historical key frames, based on the relative pose information and the optimized pose information of the received key frames to be applied, the GPU can continue to draw the multi-level staircases between the two floors and the map of the second floor in the display interface, thereby updating the map data.

Of course, in the actual application process, according to the scheme of the embodiments of the present disclosure, maps in many scenes such as autonomous driving can also be updated, and the embodiments of the present disclosure do not limit this.

According to the technical scheme of the embodiments of the present disclosure, the key frame group to be updated comprising at least one key frame to be applied is positioned based on the SLAM system, and whether a received current frame is a key frame is determined; if it is determined that the current frame is a key frame, the key frame group to be updated is updated according to the preset frame number and the current frame, so that the updated key frame group to be updated is obtained; and the key frames to be applied in the updated key frame group to be updated are optimized, so as to update the relative poses of the key frames to be applied and perform image rendering based on the updated relative poses. This not only improves the positioning accuracy in the SLAM space and optimizes the image rendering effect, but also avoids the computational overhead caused by extracting and matching the feature points in the image, enhances the efficiency of image rendering, and ensures real-time processing of images captured by the mobile terminal.

FIG. 2 is a schematic structural diagram of an image rendering apparatus according to embodiments of the present disclosure. As shown in FIG. 2, the apparatus includes a key frame determination module 210, an updating module 220, and a to-be-applied key frame optimization module 230.

The key frame determination module 210 is configured to determine whether a current frame that is received is a key frame based on a key frame group to be updated located by a simultaneous localization and mapping system, and the key frame group to be updated comprises at least one key frame to be applied.

The updating module 220 is configured to, in response to determining that the current frame that is received is a key frame, update the key frame group to be updated according to a preset frame number and the current frame to obtain an updated key frame group to be updated.

The to-be-applied key frame optimization module 230 is configured to optimize a key frame to be applied in the updated key frame group to be updated, and update a relative pose of the key frame to be applied, so as to perform image rendering based on an updated relative pose.

On the basis of the above technical schemes, the image rendering apparatus also includes an initialization key frame determination module and a to-be-applied key frame determination module.

The initialization key frame determination module is configured to, in response to receiving a plurality of consecutive frame images for the first time, preprocess the plurality of consecutive frame images, and determine at least one initialization key frame. Here, the preprocessing includes an operation of eliminating rotational influence.

The to-be-applied key frame determination module is configured to take the at least one initialization key frame as the key frames to be applied in the key frame group to be updated.

On the basis of the above technical schemes, the image rendering apparatus also includes an optimization pose determination module.

The optimization pose determination module is configured to determine point cloud data to be processed in the current frame based on a corner detection algorithm, so as to process the point cloud data to be processed based on the at least one key frame to be applied to obtain an optimized pose of the current frame, thereby determining whether the current frame is a key frame.

On the basis of the above technical schemes, the key frame determination module 210 includes a target feature point determination unit and a key frame determination unit.

The target feature point determination unit is configured to determine target feature points of the current frame and a displacement parallax between the current frame and the at least one key frame to be applied.

The key frame determination unit is configured to, in response to the number of the target feature points reaching a first preset number threshold and the displacement parallax being greater than a first preset displacement parallax threshold, determine that the current frame is a key frame.

Alternatively, the target feature point determination unit is further configured to determine co-visibility feature points between the current frame and the at least one key frame to be applied, perform downsampling processing on the current frame based on the co-visibility feature points to determine target feature points, and determine a displacement deviation between the current frame and the key frame to be applied.

Alternatively, the key frame determination unit is further configured to, in response to the number of the target feature points being less than the number of feature points to be processed in the current frame and the displacement deviation being less than a second preset displacement deviation, determine that the current frame is a key frame.

Alternatively, the target feature point determination unit is further configured to downsample point cloud data to be processed in the current frame to obtain target feature points.

Alternatively, the key frame determination unit is further configured to determine a displacement deviation between the current frame and the at least one key frame to be applied; and in response to the number of the target feature points being less than or equal to the number of co-visibility feature points and the displacement deviation being less than a third preset displacement deviation, determine that the current frame is a key frame. Here, the co-visibility feature point is a co-visibility point between the current frame and the key frame to be applied.

Alternatively, the updating module 220 is further configured to, in response to the number of the at least one key frame to be applied being less than the preset frame number, update the current frame to the key frame group to be updated to obtain the updated key frame group to be updated; and in response to the number of the at least one key frame to be applied being greater than or equal to the preset frame number, update the current frame to the key frame group to be updated, and remove a key frame to be applied with a longest interval from current time from the key frame group to be updated to obtain the updated key frame group to be updated.

Alternatively, the to-be-applied key frame optimization module 230 is further configured to optimize the key frames to be applied based on a bundle adjustment method, and update the relative poses of the key frames to be applied.

On the basis of the above technical schemes, the image rendering apparatus also includes a map data updating module.

The map data updating module is configured to optimize the key frames to be applied based on a bundle adjustment method, and update the relative poses of the key frames to be applied.

According to the technical scheme of the embodiments of the present disclosure, the key frame group to be updated comprising at least one key frame to be applied is located based on the SLAM system, and whether a received current frame is a key frame is determined; in response to determining that the current frame is a key frame, the key frame group to be updated is updated according to the preset frame number and the current frame, so that the updated key frame group to be updated is obtained; and the key frames to be applied in the updated key frame group to be updated are optimized, so as to update the relative poses of the key frames to be applied and perform image rendering based on the updated relative poses. This not only improves the positioning accuracy in the SLAM space and optimizes the image rendering effect, but also avoids the computational overhead caused by extracting and matching the feature points in the image, enhances the efficiency of image rendering, and ensures real-time processing of images captured on the mobile terminal.

The image rendering apparatus provided by the embodiments of the present disclosure can perform the image rendering method provided by any embodiment of the present disclosure, and has corresponding functional modules for executing the method.

It is worth noting that the plurality of units and modules included in the apparatus are only divided based on functional logic, but not limited to the division manner described above, as long as corresponding functions can be achieved. In addition, the specific names of the functional units are only for the convenience of distinguishing each other, and are not used to limit the protection scope of the embodiments of the present disclosure.

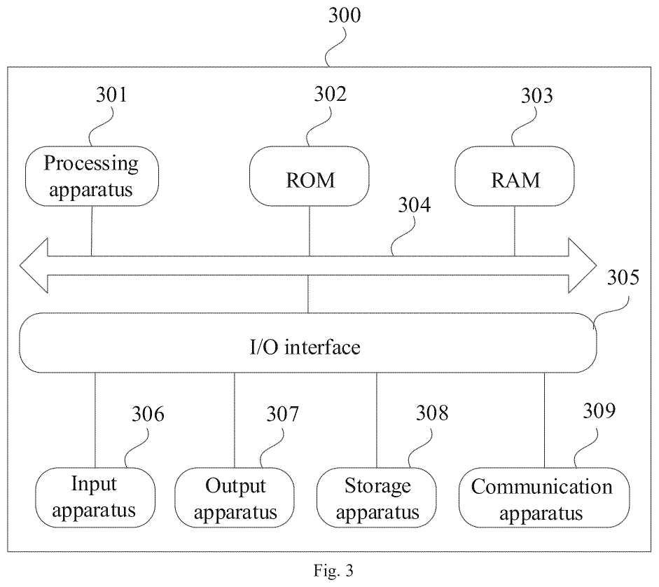

FIG. 3 is a schematic structural diagram of an electronic device provided by embodiments of the present disclosure. Hereinafter, referring to FIG. 3, which shows a structural schematic diagram of an electronic device (for example, a terminal device or a server in FIG. 3) 300 suitable for implementing an embodiment of the present disclosure. The terminal device in the embodiments of the present disclosure can include, but is not limited to, mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital television (TV), a desktop computer, or the like. The electronic device shown in FIG. 3 is only an example, and should not bring any limitation to the functions and application scope of the embodiments of the present disclosure.

As shown in FIG. 3, the electronic device 300 may include a processing apparatus (for example, a central processing unit, a graphics processing unit, etc.) 301, which may perform various appropriate actions and processes according to programs stored in a read-only memory (ROM) 302 or programs loaded from a storage apparatus 308 into a random-access memory (RAM) 303. In the RAM 303, various programs and data required for operations of the electronic device 300 are also stored. The processing apparatus 301, the ROM 302, and the RAM 303 are connected to each other through a bus 304. An input/output (I/O) interface 305 is also connected to the bus 304.

Usually, the following apparatuses can be connected to the I/O interface 305: an input apparatus 306 including, for example, a touch screen, a touch pad, a keyboard, a mouse, a camera, a microphone, an accelerometer, a gyroscope, or the like; an output apparatus 307 including, for example, a liquid crystal display (LCD), a loudspeaker, a vibrator, or the like; a storage apparatus 308 including, for example, a magnetic tape, a hard disk, or the like; and a communication apparatus 309. The communication apparatus 309 may allow the electronic device 300 to be in wireless or wired communication with other devices to exchange data. While FIG. 3 illustrates the electronic device 300 having various apparatuses, it should be understood that not all of the illustrated apparatuses are required to be implemented or included. More or fewer apparatuses may be implemented or provided alternatively.

In particular, according to the embodiments of the present disclosure, processes described above with reference to the flowchart may be implemented as a computer software program. For example, an embodiment of the present disclosure includes a computer program product, which includes a computer program carried on a non-transitory computer-readable medium, and the computer program includes program codes for performing the method shown in the flowchart. In such an embodiment, the computer program may be downloaded and installed from a network through the communication apparatus 309, or installed from the storage apparatus 308, or installed from the ROM 302. When the computer program is executed by the processing apparatus 301, the above functions defined in the method of the embodiment of the present disclosure are performed.

The names of messages or information interacted with between a plurality of apparatuses in the implementations of the present disclosure are used for illustrative purposes only, and are not intended to limit the scope of the messages or information.

The electronic device provided in the embodiments of the present disclosure and the image rendering method provided in the above embodiments belong to the same inventive concept. Technical details not exhaustively described in this embodiment can be found in the above embodiments.

An embodiment of the present disclosure provides a computer storage medium, a computer program is stored on the computer storage medium, when the computer program is executed by a processor, the image rendering method provided by the above embodiments is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semi-conductive system, apparatus, or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus, or device. In the present disclosure, the computer-readable signal medium may include a data signal that propagates in a baseband or as a part of a carrier wave and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF), and the like, or any appropriate combination of them.

In some implementations, a client and a server may communicate by using any currently known or future developed network protocol, such as HTTP (HyperText Transfer Protocol), and may be interconnected with digital data communication (for example, the communications network) in any form or medium. Examples of the communication network include a local area network (“LAN”), a wide area network (“WAN”), the Internet (for example, the Internet), and an end-to-end network (for example, an ad hoc end-to-end network), as well as any currently known or future developed network.

The above-mentioned computer-readable medium may be included in the electronic device described above, or may exist alone without being assembled into the electronic device.

The above-described computer-readable medium carries at least one program, and when the at least one program is executed by the electronic device, the electronic device is caused to:
determine whether a current frame that is received is a key frame based on a key frame group to be updated located by a simultaneous localization and mapping system, the key frame group to be updated comprising at least one key frame to be applied;
in response to determining that the current frame that is received is a key frame, update the key frame group to be updated according to a preset frame number and the current frame to obtain an updated key frame group to be updated; and
optimize each key frame to be applied in the updated key frame group to be updated, and update a relative pose of each key frame to be applied, so as to perform image rendering based on an updated relative pose.

The computer program codes for performing the operations of the present disclosure can be written in one or more programming languages or a combination thereof. The above programming languages include but not limited to object-oriented programming languages such as Java, Smalltalk, C++, and also include conventional procedural programming languages such as the “C” language or similar programming languages. The program code can be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or connected to an external computer (for example, through the Internet using an Internet service provider).

The flowcharts and block diagrams in the accompanying drawings illustrate system architectures, functions, and operations that may be implemented by the system, the method, and the computer program product according to the various embodiments of the present disclosure. In this regard, each block in the flowcharts or block diagrams may represent a module, a program segment, or a part of codes, and the module, the program segment, or the part of codes includes one or more executable instructions for implementing specified logic functions. It should also be noted that, in some alternative implementations, functions marked in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the block diagrams and/or flowcharts and combinations of the blocks in the block diagrams and/or flowcharts may be implemented by a dedicated hardware-based system for executing specified functions or operations, or may be implemented by a combination of a dedicated hardware and computer instructions.

The units described and involved in the embodiments of the present disclosure may be implemented by software, or may be implemented by hardware. In some cases, the name of a unit does not constitute a limitation on the unit itself, for example, the first obtaining unit may also be described as “a unit for obtaining at least two Internet Protocol addresses”.

The functions described above in the present disclosure may be executed at least in part by one or more hardware logic components. For example, without limitations, exemplary types of the hardware logic components that can be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include but not be limited to an electronic, magnetic, optical, electromagnetic, infrared, or semi-conductive system, apparatus, or device, or any appropriate combination of them. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination of them.

According to at least one embodiment of the present disclosure, [Example One] provides an image rendering method, and the method includes:
determining whether a current frame that is received is a key frame based on a key frame group to be updated located by a simultaneous localization and mapping system, the key frame group to be updated comprising at least one key frame to be applied;
in response to determining that the current frame that is received is a key frame, updating the key frame group to be updated according to a preset frame number and the current frame to obtain an updated key frame group to be updated; and
optimizing each key frame to be applied in the updated key frame group to be updated, and updating a relative pose of each key frame to be applied, so as to perform image rendering based on an updated relative pose.

According to at least one embodiment of the present disclosure, [Example Two] provides an image rendering method, and the method further includes:
alternatively, in response to receiving a plurality of consecutive frame images for a first time, preprocessing the plurality of consecutive frame images, and determining at least one initialization key frame, the preprocessing comprising an operation of eliminating rotational influence; and
taking the at least one initialization key frame as the key frame to be applied in the key frame group to be updated.

According to at least one embodiment of the present disclosure, [Example Three] provides an image rendering method, and the method further includes:
alternatively, determining point cloud data to be processed in the current frame based on a corner detection algorithm, so as to process the point cloud data to be processed based on the at least one key frame to be applied to obtain an optimized pose of the current frame, thereby determining whether the current frame is a key frame.

According to at least one embodiment of the present disclosure, [Example Four] provides an image rendering method, and the method further includes:
alternatively, determining target feature points of the current frame and a displacement parallax between the current frame and the at least one key frame to be applied; and
in response to the number of the target feature points reaching a first preset number threshold and the displacement parallax being greater than a first preset displacement parallax threshold, determining that the current frame is a key frame.

According to at least one embodiment of the present disclosure, [Example Five] provides an image rendering method, and the method further includes:
alternatively, determining co-visibility feature points between the current frame and the at least one key frame to be applied, performing downsampling processing on the current frame based on the co-visibility feature points to determine target feature points, and determining a displacement deviation between the current frame and the key frame to be applied; and
in response to the number of the target feature points being less than the number of feature points to be processed in the current frame and the displacement deviation being less than a second preset displacement deviation, determining that the current frame is a key frame.

According to at least one embodiment of the present disclosure, [Example Six] provides an image rendering method, and the method further includes:
alternatively, downsampling point cloud data to be processed in the current frame to obtain target feature points;
determining a displacement deviation between the current frame and the at least one key frame to be applied; and
in response to the number of the target feature points being less than or equal to the number of co-visibility feature points and the displacement deviation being less than a third preset displacement deviation, determining that the current frame is a key frame.

The co-visibility feature point is a co-visibility point between the current frame and the key frame to be applied.

According to at least one embodiment of the present disclosure, [Example Seven] provides an image rendering method, and the method further includes:
alternatively, in response to the number of the at least one key frame to be applied being less than the preset frame number, updating the current frame to the key frame group to be updated to obtain the updated key frame group to be updated; and
in response to the number of the at least one key frame to be applied being greater than or equal to the preset frame number, updating the current frame to the key frame group to be updated, and removing a key frame to be applied with a longest interval from current time from the key frame group to be updated to obtain the updated key frame group to be updated.

According to at least one embodiment of the present disclosure, [Example Eight] provides an image rendering method, and the method further includes:
alternatively, optimizing each key frame to be applied based on a bundle adjustment method, and updating the relative pose of each key frame to be applied.

According to at least one embodiment of the present disclosure, [Example Nine] provides an image rendering method, and the method further includes:
alternatively, sending the updated relative pose and an optimized pose to a graphics processing unit, so as to update map data based on the graphics processing unit.

According to at least one embodiment of the present disclosure, [Example Ten] provides an image rendering apparatus, and the apparatus includes:
a key frame determination module, configured to determine whether a current frame that is received is a key frame based on a key frame group to be updated located by a simultaneous localization and mapping system, the key frame group to be updated comprising at least one key frame to be applied;
an updating module, configured to, in response to determining that the current frame that is received is a key frame, update the key frame group to be updated according to a preset frame number and the current frame to obtain an updated key frame group to be updated; and
a to-be-applied key frame optimization module, configured to optimize each key frame to be applied in the updated key frame group to be updated, and update a relative pose of each key frame to be applied, so as to perform image rendering based on an updated relative pose.

In addition, although a plurality of operations have been described in a particular order, it shall not be understood as requiring that such operations are performed in the shown particular order or in a sequential order. Under certain circumstances, multitasking and parallel processing may be advantageous. Similarly, although some specific implementation details are included in the above discussions, these shall not be construed as limitations to the scope of the present disclosure. Some features described in the context of a separate embodiment may also be implemented in combination in a single embodiment. Conversely, various features described in the context of a single embodiment may also be implemented in a plurality of embodiments individually or in any appropriate sub-combination.

1. An image rendering method, comprising:
determining whether a current frame that is received is a key frame based on a key frame group to be updated located by a simultaneous localization and mapping system, wherein the key frame group to be updated comprises at least one key frame to be applied;
in response to determining that the current frame that is received is a key frame, updating the key frame group to be updated according to a preset frame number and the current frame to obtain an updated key frame group to be updated; and
optimizing a key frame to be applied in the updated key frame group to be updated, and updating a relative pose of the key frame to be applied to obtain an updated relative pose, so as to perform image rendering based on the updated relative pose.

2. The method according to claim 1, before the determining whether a current frame that is received is a key frame based on a key frame group to be updated located by a simultaneous localization and mapping system, further comprising:
in response to receiving a plurality of consecutive frame images for a first time, preprocessing the plurality of consecutive frame images, and determining at least one initialization key frame, wherein the preprocessing comprises an operation of eliminating rotational influence; and
taking the at least one initialization key frame as the at least one key frame to be applied in the key frame group to be updated.

3. The method according to claim 1, before determining whether the current frame is a key frame, further comprising:
determining point cloud data to be processed in the current frame based on a corner detection algorithm, so as to process the point cloud data to be processed based on the at least one key frame to be applied to obtain an optimized pose of the current frame, thereby determining whether the current frame is a key frame.

4. The method according to claim 1, wherein the determining whether a current frame that is received is a key frame based on a key frame group to be updated located by a simultaneous localization and mapping system comprises:
determining at least one target feature point of the current frame and a displacement parallax between the current frame and the at least one key frame to be applied; and
in response to a number of the at least one target feature point reaching a first preset number threshold and the displacement parallax being greater than a first preset displacement parallax threshold, determining that the current frame is a key frame.

5. The method according to claim 1, wherein the determining whether a current frame that is received is a key frame based on a key frame group to be updated located by a simultaneous localization and mapping system comprises:
determining at least one co-visibility feature point between the current frame and the at least one key frame to be applied, performing downsampling processing on the current frame based on the at least one_co-visibility feature point to determine at least one target feature point, and determining a displacement deviation between the current frame and the at least one key frame to be applied; and
in response to a number of the at least one target feature point being less than a number of at least one feature point to be processed in the current frame and the displacement deviation being less than a second preset displacement deviation, determining that the current frame is a key frame.

6. The method according to claim 1, wherein the determining whether a current frame that is received is a key frame based on a key frame group to be updated located by a simultaneous localization and mapping system comprises:
downsampling point cloud data to be processed in the current frame to obtain at least one target feature point;
determining a displacement deviation between the current frame and the at least one key frame to be applied; and
in response to a number of the at least one target feature point being less than or equal to a number of at least one co-visibility feature point and the displacement deviation being less than a third preset displacement deviation, determining that the current frame is a key frame,
wherein the co-visibility feature point is a co-visibility point between the current frame and the at least one key frame to be applied.

7. The method according to claim 1, wherein the updating the key frame group to be updated according to a preset frame number and the current frame to obtain an updated key frame group to be updated comprises:
in response to a number of the at least one key frame to be applied being less than the preset frame number, updating the current frame to the key frame group to be updated to obtain the updated key frame group to be updated; and
in response to the number of the at least one key frame to be applied being greater than or equal to the preset frame number, updating the current frame to the key frame group to be updated, and removing a key frame to be applied with a longest interval from current time from the key frame group to be updated to obtain the updated key frame group to be updated.

8. The method according to claim 1, wherein the optimizing a key frame to be applied in the updated key frame group to be updated, and updating a relative pose of the key frame to be applied comprises:
optimizing the key frame to be applied based on a bundle adjustment method, and updating the relative pose of the key frame to be applied.

9. The method according to claim 1, further comprising:
sending the updated relative pose and an optimized pose of the key frame to be applied in the updated key frame group to be updated to a graphics processing unit, so as to update map data based on the graphics processing unit.

10. (canceled)

11. An electronic device, comprising:
at least one processor; and
a storage apparatus, configured to store at least one program;
wherein when the at least one program is executed by the at least one processor, the at least one processor implements an image rendering method,
the image rendering method comprises:
determining whether a current frame that is received is a key frame based on a key frame group to be updated located by a simultaneous localization and mapping system, wherein the key frame group to be updated comprises at least one key frame to be applied;
in response to determining that the current frame that is received is a key frame, updating the key frame group to be updated according to a preset frame number and the current frame to obtain an updated key frame group to be updated; and
optimizing a key frame to be applied in the updated key frame group to be updated, and updating a relative pose of the key frame to be applied to obtain an updated relative pose, so as to perform image rendering based on the updated relative pose.

12. A non-transitory computer-readable storage medium, storing computer-executable instructions, wherein the computer-executable instructions, when executed by a computer processor, perform an image rendering method,
the image rendering method comprises:
determining whether a current frame that is received is a key frame based on a key frame group to be updated located by a simultaneous localization and mapping system, wherein the key frame group to be updated comprises at least one key frame to be applied;
in response to determining that the current frame that is received is a key frame, updating the key frame group to be updated according to a preset frame number and the current frame to obtain an updated key frame group to be updated; and
optimizing a key frame to be applied in the updated key frame group to be updated, and updating a relative pose of the key frame to be applied to obtain an updated relative pose, so as to perform image rendering based on the updated relative pose.

13. The electronic device according to claim 11, wherein before performing the step of determining whether a current frame that is received is a key frame based on a key frame group to be updated located by a simultaneous localization and mapping system, when the at least one program is executed by the at least one processor, the at least one processor further performs:
in response to receiving a plurality of consecutive frame images for a first time, preprocessing the plurality of consecutive frame images, and determining at least one initialization key frame, wherein the preprocessing comprises an operation of eliminating rotational influence; and
taking the at least one initialization key frame as the at least one key frame to be applied in the key frame group to be updated.

14. The electronic device according to claim 11, wherein before performing the step of determining whether the current frame is a key frame, when the at least one program is executed by the at least one processor, the at least one processor further performs:
determining point cloud data to be processed in the current frame based on a corner detection algorithm, so as to process the point cloud data to be processed based on the at least one key frame to be applied to obtain an optimized pose of the current frame, thereby determining whether the current frame is a key frame.

15. The electronic device according to claim 11, wherein when performing the step of determining whether a current frame that is received is a key frame based on a key frame group to be updated located by a simultaneous localization and mapping system, the at least one processor performs:
determining at least one target feature point of the current frame and a displacement parallax between the current frame and the at least one key frame to be applied; and
in response to a number of the at least one target feature point reaching a first preset number threshold and the displacement parallax being greater than a first preset displacement parallax threshold, determining that the current frame is a key frame.

16. The electronic device according to claim 11, wherein when performing the step of determining whether a current frame that is received is a key frame based on a key frame group to be updated located by a simultaneous localization and mapping system, the at least one processor performs:
determining at least one co-visibility feature point between the current frame and the at least one key frame to be applied, performing downsampling processing on the current frame based on the at least one co-visibility feature point to determine at least one target feature point, and determining a displacement deviation between the current frame and the at least one key frame to be applied; and
in response to a number of the at least one target feature point being less than a number of at least one feature point to be processed in the current frame and the displacement deviation being less than a second preset displacement deviation, determining that the current frame is a key frame.

17. The electronic device according to claim 11, wherein when performing the step of determining whether a current frame that is received is a key frame based on a key frame group to be updated located by a simultaneous localization and mapping system, the at least one processor performs:
downsampling point cloud data to be processed in the current frame to obtain at least one target feature point;
determining a displacement deviation between the current frame and the at least one key frame to be applied; and
in response to a number of the at least one target feature point being less than or equal to a number of at least one co-visibility feature point and the displacement deviation being less than a third preset displacement deviation, determining that the current frame is a key frame,
wherein the co-visibility feature point is a co-visibility point between the current frame and the at least one key frame to be applied.

18. The electronic device according to claim 11, wherein when performing the step of updating the key frame group to be updated according to a preset frame number and the current frame to obtain an updated key frame group to be updated, the at least one processor performs:
in response to a number of the at least one key frame to be applied being less than the preset frame number, updating the current frame to the key frame group to be updated to obtain the updated key frame group to be updated; and
in response to the number of the at least one key frame to be applied being greater than or equal to the preset frame number, updating the current frame to the key frame group to be updated, and removing a key frame to be applied with a longest interval from current time from the key frame group to be updated to obtain the updated key frame group to be updated.

19. The electronic device according to claim 11, wherein when performing the step of optimizing a key frame to be applied in the updated key frame group to be updated, and updating a relative pose of the key frame to be applied, the at least one processor performs:
optimizing the key frame to be applied based on a bundle adjustment method, and updating the relative pose of the key frame to be applied.

20. The electronic device according to claim 11, wherein when the at least one program is executed by the at least one processor, the at least one processor further performs:
sending the updated relative pose and an optimized pose of the key frame to be applied in the updated key frame group to be updated to a graphics processing unit, so as to update map data based on the graphics processing unit.

21. The non-transitory computer-readable storage medium according to claim 12, wherein before performing the step of determining whether a current frame that is received is a key frame based on a key frame group to be updated located by a simultaneous localization and mapping system, the computer-executable instructions, when executed by the computer processor, further perform:
in response to receiving a plurality of consecutive frame images for a first time, preprocessing the plurality of consecutive frame images, and determining at least one initialization key frame, wherein the preprocessing comprises an operation of eliminating rotational influence; and
taking the at least one initialization key frame as the at least one key frame to be applied in the key frame group to be updated.
